(19) United States
(12) Patent Application Publication
(10) Pub. No.: US 2025/0105543 A1
(43) Pub. Date: Mar. 27, 2025

(54) Terminal and Electrical Connection Assembly

(71) Applicant: Tyco Electronics (Shanghai) Co., Ltd., Shanghai (CN)

(72) Inventors: Xiaozhi (George) Fu, Shanghai (CN); Wei Zhang, Shanghai (CN); Dingbing (Frank) Fan, Shanghai (CN)

(73) Assignee: Tyco Electronics (Shanghai) Co., Ltd., Shanghai (CN)

(21) Appl. No.: 18/894,092

(22) Filed: Sep. 24, 2024

(30) Foreign Application Priority Data
Sep. 25, 2023 (CN) 202322610967.9

(51) Int. Cl. H01R 13/11; H01R 12/71

(52) U.S. Cl. CPC H01R 13/112; H01R 12/718

(57) ABSTRACT

A terminal includes first and second rigid side plates, a rigid top plate, first and second elastic connection arms, and a pair of elastic clamping arms. The second rigid side plate is arranged opposite to the first rigid side plate. The rigid top plate is located between the first and second rigid side plates. The first elastic connecting arm is connected between the rigid top plate and the first rigid side plate. The second elastic connecting arm is connected between the rigid top plate and the second rigid side plate. The pair of elastic clamping arms are connected to the rigid top plate and are adapted to clamp an inserted mating plug to electrically contact with the mating plug.

### CROSS-REFERENCE TO RELATED APPLICATION

This application claims the benefit of Chinese Patent Application No. CN202322610967.9 filed on Sep. 25, 2023, in the State Intellectual Property Office of China, the whole disclosure of which is incorporated herein by reference.

### FIELD OF THE DISCLOSURE

The present disclosure relates to a terminal and an electrical connection assembly including the terminal.

### BACKGROUND OF THE INVENTION

In the prior art, it is sometimes necessary to install multiple terminals simultaneously on a circuit board. Multiple mating plugs are adapted to be respectively inserted into or onto the multiple terminals to make electrical contact therewith. In order to enable the insertion of the multiple mating plugs onto the multiple terminals simultaneously, the installation position error of each terminal should be as small as possible or zero. However, in practical applications, there are always some errors in the installation position of the terminals, making it difficult to achieve high accuracy. This leads to difficulty in mating the multiple mating plugs with the multiple terminals simultaneously, which brings great difficulties to the mating operation of the product. Therefore, in the prior art, in order to reduce the difficulty of mating, it is necessary to improve the installation position accuracy of terminals. However, this typically leads to a significant increase in cost.

### SUMMARY OF THE INVENTION

According to an embodiment of the present disclosure, a terminal includes first and second rigid side plates, a rigid top plate, first and second elastic connection arms, and a pair of elastic clamping arms. The second rigid side plate is arranged opposite to the first rigid side plate. The rigid top plate is located between the first and second rigid side plates. The first elastic connecting arm is connected between the rigid top plate and the first rigid side plate. The second elastic connecting arm is connected between the rigid top plate and the second rigid side plate. The pair of elastic clamping arms are connected to the rigid top plate and are adapted to clamp an inserted mating plug to electrically contact with the mating plug.

### BRIEF DESCRIPTION OF THE DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of an electrical connection assembly according to an exemplary embodiment of the present disclosure;

FIG. 2 shows a vertical sectional view of an electrical connection assembly according to an exemplary embodiment of the present disclosure;

FIG. 3 shows an illustrative perspective view of a terminal according to an exemplary embodiment of the present disclosure;

FIG. 4 shows a vertical sectional view of a terminal according to an exemplary embodiment of the present disclosure;

FIG. 5 shows a planar sectional view of an electrical connection assembly according to an exemplary embodiment of the present disclosure, wherein the mating plug is centrally inserted between the pair of elastic clamping arms along a symmetry plane; and

FIG. 6 shows a planar sectional view of an electrical connection assembly according to an exemplary embodiment of the present disclosure, wherein the mating plug is biased towards one side of the symmetry plane and inserted between the pair of elastic clamping arms parallel to the symmetry plane.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a terminal includes: a first rigid side plate; a second rigid side plate which is opposite to the first rigid side plate; a rigid top plate located between the first and second rigid side plates; a first elastic connecting arm which is connected between the rigid top plate and the first rigid side plate; a second elastic connecting arm which is connected between the rigid top plate and the second rigid side plate; and a pair of elastic clamping arms connected to the rigid top plate for clamping an inserted mating plug to electrically contact with the mating plug.

According to another embodiment, an electrical connection assembly includes a circuit board, and the above terminal installed thereon. The first rigid side plate and the second rigid side plate of the terminal are fixed and electrically connected to the circuit board. The rigid top plate of the terminal is suspended above the circuit board by the first elastic connection arm and the second elastic connection arm.

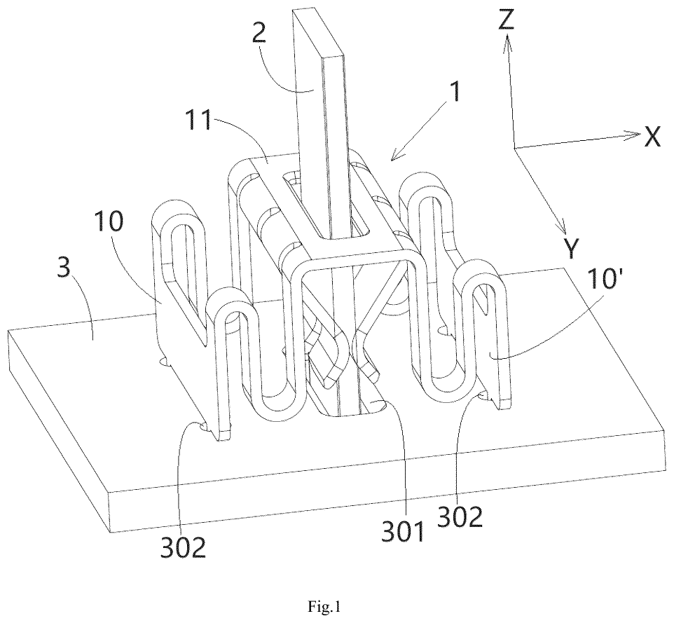

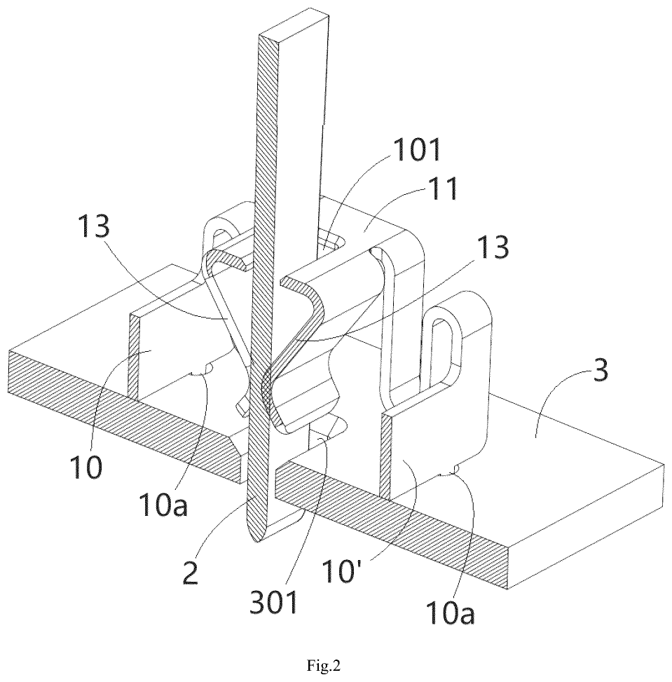

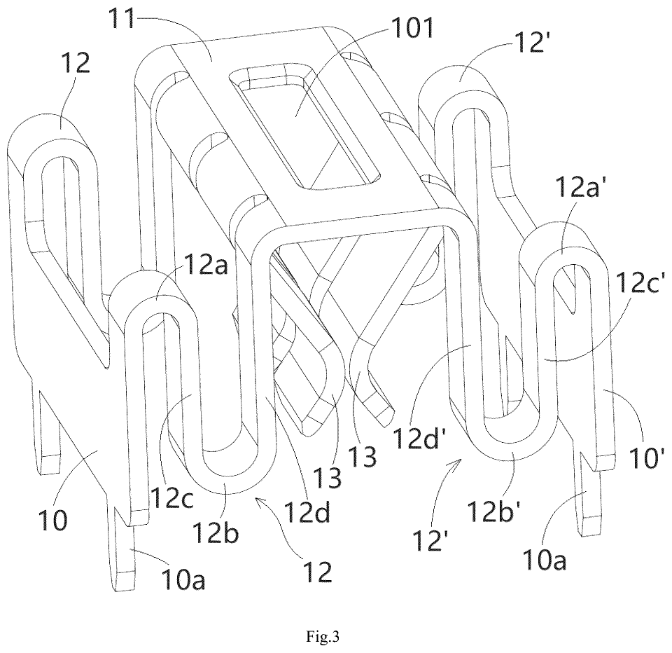

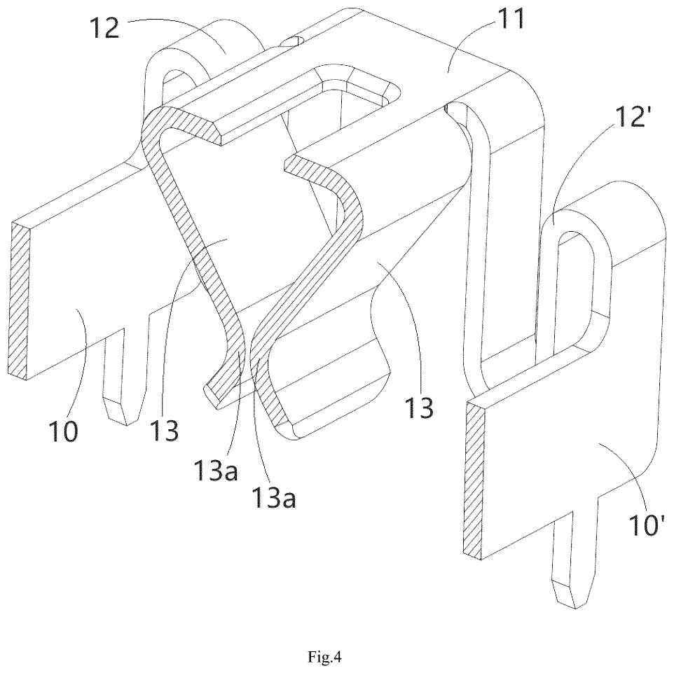

FIG. 1 shows an illustrative perspective view of an electrical connection assembly according to an exemplary embodiment of the present disclosure. FIG. 2 shows a vertical sectional view of an electrical connection assembly according to an exemplary embodiment of the present disclosure. FIG. 3 shows an illustrative perspective view of terminal 1 according to an exemplary embodiment of the present disclosure. FIG. 4 shows a vertical sectional view of terminal 1 according to an exemplary embodiment of the present disclosure.

As shown in FIGS. 1-4, in an exemplary embodiment of the present disclosure, a terminal 1 is disclosed. The terminal 1 includes: a first rigid side plate 10, a second rigid side plate 10′, a rigid top plate 11, a first elastic connecting arm 12, a second elastic connecting arm 12′, and a pair of elastic clamping arms 13. The second rigid side plate 10′ is opposite to the first rigid side plate 10. The rigid top plate 11 is located between the first and second rigid side plates 10 and 10′. The first elastic connecting arm 12 is connected between the rigid top plate 11 and the first rigid side plate 10. The second elastic connecting arm 12′ is connected between the rigid top plate 11 and the second rigid side plate 10′. The pair of elastic clamping arms 13 are connected to the rigid top plate 11 for clamping an inserted mating plug 2 to electrically contact with the mating plug 2.

The rigid top plate 11 extends along a first direction (a first horizontal direction in the figure) X and a second direction (a second horizontal direction in the figure) Y perpendicular to the first direction X. The first rigid side plate 10 and the second rigid side plate 10′ are opposite in the first direction X and extend along the second direction Y and a third direction (a vertical direction in the figure) Z perpendicular to the first and second directions X and Y.

The first rigid side plate 10 and the second rigid side plate 10′ each has opposite upper and lower side edges in the third direction Z, and the rigid top plate 11 has opposite first and second side edges in the first direction X. The first elastic connecting arm 12 is connected between the first side edge of the rigid top plate 11 and the upper side edge of the first rigid side plate 10, and the second elastic connecting arm 12′ is connected between the second side edge of the rigid top plate 11 and the upper side edge of the second rigid side plate 10′.

In the illustrated embodiments, a connecting pin 10a is formed on the lower side edge of each of the first rigid side plate 10 and the second rigid side plate 10′. The connecting pin 10a is adapted to be inserted into a hole 302 formed in a circuit board 3. The connecting pin 10a is adapted to fix and electrically connect the first rigid side plate 10 and the second rigid side plate 10′ to the circuit board 3.

The first elastic connecting arm 12 and the second elastic connecting arm 12′ are symmetrically arranged at both sides of the rigid top plate 11. The first rigid side plate 10 and the second rigid side plate 10′ are symmetrically arranged at both sides of the rigid top plate 11.

The pair of elastic clamping arms 13 are respectively connected to the first and second side edges of the rigid top plate 11 and symmetrically arranged below the rigid top plate 11. An opening 101 is formed in the rigid top plate 11 to allow the mating plug 2 to be inserted between the pair of elastic clamping arms 13 through the opening 101.

The elastic clamping arm 13 has an arc-shaped contact portion 13a located at its end, and the arc-shaped contact portions 13a of the pair of elastic clamping arms 13 are located below the opening 101 of the rigid top plate 11, for clamping and electrically contacting the inserted mating plug 2.

The terminal includes a pair of first elastic connecting arms 12, which are opposite to each other in the second direction Y and spaced by a predetermined distance. The terminal includes a pair of second elastic connecting arms 12′, which are opposite to each other in the second direction Y and spaced by a predetermined distance. One of the pair of elastic clamping arms 13 is located between the pair of first elastic connecting arms 12, and the other of the pair of elastic clamping arms 13 is located between the pair of second elastic connecting arms 12′.

The first elastic connecting arm 12 comprises: a first curved arm 12a, a first straight arm 12c, a second curved arm 12b, and a second straight arm 12d. One end of the first curved arm 12a is connected to the upper side edge of the first rigid side plate 10. One end of the first straight arm 12c is connected to the other end of the first curved arm 12a. One end of the second curved arm 12b is connected to the other end of the first straight arm 12c. One end of the second straight arm 12d is connected to the other end of the second curved arm 12b, and the other end of the second straight arm 12d is connected to the first side edge of the rigid top plate 11.

The first curved arm 12a is U-shaped with its opening facing downwards, the second curved arm 12b is U-shaped with its opening facing upwards, and the first straight arm 12c and the second straight arm 12d extend parallel to each other along the third direction Z.

The second elastic connecting arm 12′ comprises: a third curved arm 12a′, a third straight arm 12c′, a fourth curved arm 12b′, and a fourth straight arm 12d′. One end of the third curved arm 12a′ is connected to the upper side edge of the second rigid side plate 10′. One end of the third straight arm 12c′ is connected to the other end of the third curved arm 12a′. One end of the fourth curved arm 12b′ is connected to the other end of the third straight arm 12c′. One end of the fourth straight arm 12d′ is connected to the other end of the fourth curved arm 12b′, and the other end of the fourth straight arm 12d′ is connected to the second side edge of the rigid top plate 11.

The third curved arm 12a′ is U-shaped with its opening facing downwards, the fourth curved arm 12b′ is U-shaped with its opening facing upwards, and the third straight arm 12c′and the fourth straight arm 12d′ extend parallel to each other along the third direction Z.

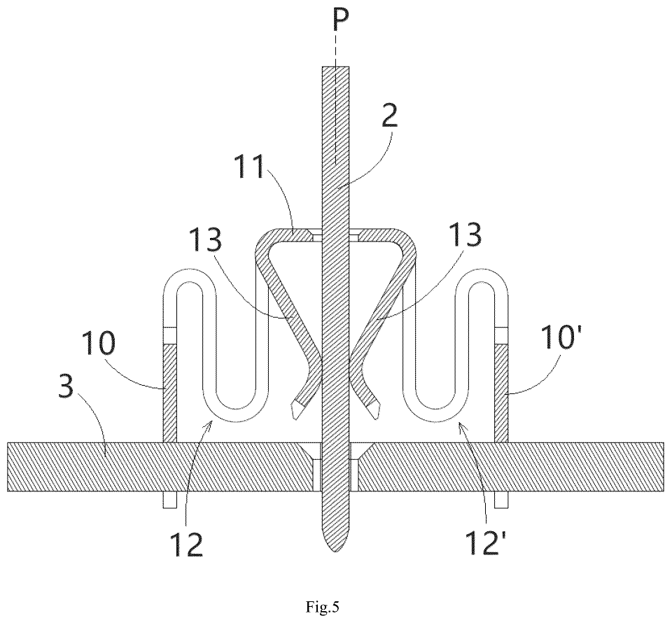

FIG. 5 shows a planar sectional view of an electrical connection assembly according to an exemplary embodiment of the present disclosure, wherein the mating plug 2 is centrally inserted between the pair of elastic clamping arms 13 along the symmetry plane P.

As shown in FIGS. 1-5, in the illustrated embodiment, the pair of elastic clamping arms 13 are symmetrically arranged at both sides of the symmetry plane P perpendicular to the first direction X. When the mating plug 2 is inserted between the pair of elastic clamping arms 13 along the symmetry plane P, the first elastic connecting arm 12 and the second elastic connecting arm 12′ do not undergo elastic deformation, so that the rigid top plate 11 does not move.

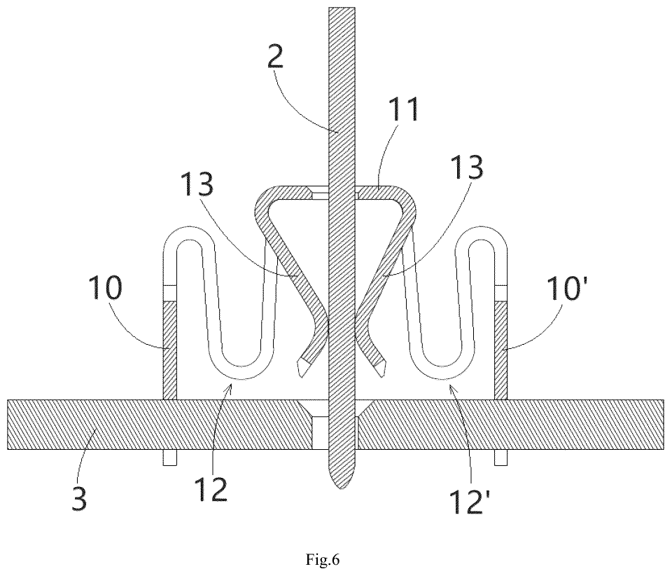

FIG. 6 shows a planar sectional view of an electrical connection assembly according to an exemplary embodiment of the present disclosure, wherein the mating plug 2 is biased towards one side of the symmetry plane P and inserted between the pair of elastic clamping arms 13 in a direction parallel to the symmetry plane P.

As shown in FIGS. 1-6, in the illustrated embodiments, when the mating plug 2 is biased towards one side of the symmetry plane P and inserted between the pair of elastic clamping arms 13 in a direction parallel to the symmetry plane P, the first elastic connecting arm 12 and the second elastic connecting arm 12′ undergo elastic deformation, causing the rigid top plate 11 to shift but still remain in an orientation perpendicular to the third direction Z. When the mating plug 2 is inserted between the pair of elastic clamping arms 13 in a direction inclined to the symmetry plane P, the first elastic connecting arm 12 and the second elastic connecting arm 12′ undergo elastic deformation, causing the rigid top plate 11 to shift and tilt.

An electrical connection assembly is also disclosed. The electrical connection assembly includes: a circuit board 3 and the above terminal 1. The terminal 1 is installed on the circuit board 3. The first rigid side plate 10 and the second rigid side plate 10′ of the terminal 1 are fixed and electrically connected to the circuit board 3, and the rigid top plate 11 of the terminal 1 is suspended above the circuit board 3 by the first elastic connection arm 12 and the second elastic connection arm 12′.

A hole 302 is formed in the circuit board 3, and a connecting pin 10a is formed on the lower side edge of each of the first rigid side plate 10 and the second rigid side plate 10′. The connecting pin 10a is inserted into the hole 302 on the circuit board 3 to fix and electrically connect the first rigid side plate 10 and the second rigid side plate 10′ to the circuit board 3. A slot 301 corresponding to the opening 101 on the rigid top plate 11 is formed in the circuit board 3 to allow the mating plug 2 inserted between the pair of elastic clamping arms 13 to pass through the slot 301 of the circuit board 3.

The electrical connection assembly further comprises a mating plug 2, which is inserted between the pair of elastic clamping arms 13 of the terminal 1 to be electrically connected to the terminal 1. The electrical connection assembly comprises multiple terminals 1, which are arranged in an array on the circuit board 3. The electrical connection assembly also includes multiple mating plugs 2. Multiple mating plugs 2 are suitable for simultaneously inserting into multiple terminals 1, respectively.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal, comprising:
a first rigid side plate;
a second rigid side plate opposite to the first rigid side plate;
a rigid top plate located between the first and second rigid side plates;
a first elastic connecting arm connected between the rigid top plate and the first rigid side plate;
a second elastic connecting arm connected between the rigid top plate and the second rigid side plate; and
a pair of elastic clamping arms connected to the rigid top plate and adapted to clamp an inserted mating plug to electrically contact with the mating plug.

2. The terminal according to claim 1, wherein the rigid top plate extends along a first direction and a second direction perpendicular to each other, and the first rigid side plate and the second rigid side plate are opposite to each other in the first direction and extend along the second direction and a third direction perpendicular to the first and second directions.

3. The terminal according to claim 2, wherein:
the first rigid side plate and the second rigid side plate each has opposite upper and lower side edges in the third direction, and the rigid top plate has opposite first and second side edges in the first direction; and
the first elastic connecting arm is connected between the first side edge of the rigid top plate and the upper side edge of the first rigid side plate, and the second elastic connecting arm is connected between the second side edge of the rigid top plate and the upper side edge of the second rigid side plate.

4. The terminal according to claim 3, wherein a connecting pin is formed on the lower side edge of each of the first rigid side plate and the second rigid side plate, the connecting pin is adapted to be inserted into a hole formed in a circuit board to fix and electrically connect the first rigid side plate and the second rigid side plate to the circuit board.

5. The terminal according to claim 3, wherein:
the first elastic connecting arm and the second elastic connecting arm are symmetrically arranged at both sides of the rigid top plate; and
the first rigid side plate and the second rigid side plate are symmetrically arranged at both sides of the rigid top plate.

6. The terminal according to claim 5, wherein:
the pair of elastic clamping arms are respectively connected to the first and second side edges of the rigid top plate and symmetrically arranged below the rigid top plate; and
an opening is formed in the rigid top plate to allow the mating plug to be inserted between the pair of elastic clamping arms through the opening.

7. The terminal according to claim 6, wherein the elastic clamping arm has an arc-shaped contact portion located at its end, and the arc-shaped contact portions of the pair of elastic clamping arms are located below the opening of the rigid top plate for clamping and electrically contacting with the inserted mating plug.

8. The terminal according to claim 6, wherein:
the terminal comprises a pair of first elastic connecting arms opposite to each other in the second direction and spaced by a predetermined distance;
the terminal comprises a pair of second elastic connecting arms opposite to each other in the second direction and spaced by a predetermined distance; and
one of the pair of elastic clamping arms is located between the pair of first elastic connecting arms, and the other of the pair of elastic clamping arms is located between the pair of second elastic connecting arms.

9. The terminal according to claim 3, wherein the first elastic connecting arm comprises of:
a first curved arm, one end of which is connected to the upper side edge of the first rigid side plate;
a first straight arm, one end of which is connected to the other end of the first curved arm;
a second curved arm, one end of which is connected to the other end of the first straight arm; and
a second straight arm, one end of which is connected to the other end of the second curved arm, and the other end of which is connected to the first side edge of the rigid top plate.

10. The terminal according to claim 9, wherein the first curved arm is U-shaped with its opening facing downwards, the second curved arm is U-shaped with its opening facing upwards, and the first straight arm and the second straight arm extend in a straight line along the third direction and are parallel to each other.

11. The terminal according to claim 9, wherein the second elastic connecting arm comprises of:
a third curved arm, one end of which is connected to the upper side edge of the second rigid side plate;
a third straight arm, one end of which is connected to the other end of the third curved arm;
a fourth curved arm, one end of which is connected to the other end of the third straight arm; and
a fourth straight arm, one end of which is connected to the other end of the fourth curved arm, and the other end of which is connected to the second side edge of the rigid top plate.

12. The terminal according to claim 11, wherein the third curved arm is U-shaped with its opening facing downwards, the fourth curved arm is U-shaped with its opening facing upwards, and the third straight arm and the fourth straight arm extend in a straight line along the third direction and are parallel to each other.

13. The terminal according to claim 2, wherein:
the pair of elastic clamping arms are symmetrically arranged at both sides of a symmetry plane perpendicular to the first direction; and
when the mating plug is inserted centrally along the symmetry plane between the pair of elastic clamping arms, the first elastic connecting arm and the second elastic connecting arm do not undergo elastic deformation, so that the rigid top plate does not move.

14. The terminal according to claim 13, wherein when the mating plug is biased towards one side of the symmetry plane and inserted between the pair of elastic clamping arms in a direction parallel to the symmetry plane, the first elastic connecting arm and the second elastic connecting arm undergo elastic deformation, causing the rigid top plate to shift but remain in an orientation perpendicular to the third direction.

15. The terminal according to claim 13, wherein when the mating plug is inserted between the pair of elastic clamping arms in a direction inclined to the symmetry plane, the first elastic connecting arm and the second elastic connecting arm undergo elastic deformation, causing the rigid top plate to shift and tilt.

16. An electrical connection assembly, comprises:
a circuit board; and
a terminal, including:
a first rigid side plate;
a second rigid side plate opposite to the first rigid side plate, the first rigid side plate and the second rigid side plate of the terminal are fixed and electrically connected to the circuit board;
a rigid top plate located between the first and second rigid side plates;
a first elastic connecting arm connected between the rigid top plate and the first rigid side plate;
a second elastic connecting arm connected between the rigid top plate and the second rigid side plate, the rigid top plate suspended above the circuit board by the first elastic connection arm and the second elastic connection arm; and
a pair of elastic clamping arms connected to the rigid top plate adapted to clamp an inserted mating plug to electrically contact with the mating plug.

17. The electrical connection assembly according to claim 16, wherein a hole is formed in the circuit board, and a connecting pin is formed on the lower side edge of each of the first rigid side plate and the second rigid side plate, the connecting pin is inserted into the hole on the circuit board to fix and electrically connect the first rigid side plate and the second rigid side plate to the circuit board.

18. The electrical connection assembly according to claim 16, wherein a slot corresponding to the opening on the rigid top plate is formed in the circuit board to allow the mating plug inserted between the pair of elastic clamping arms to pass through the circuit board through the slot.

19. The electrical connection assembly according to claim 16, further comprising a mating plug inserted between the pair of elastic clamping arms of the terminal to electrically connect with the terminal.

20. The electrical connection assembly according to claim 16, wherein:
the electrical connection assembly comprises multiple terminals arranged in an array on the circuit board; and
the electrical connection assembly comprises multiple mating plugs adapted to be simultaneously inserted into the multiple terminals, respectively.
